(19) United States
(12) Patent Application Publication
(10) Pub. No.: US 2023/0034904 A1
(43) Pub. Date: Feb. 2, 2023

(54) SYSTEMS AND METHODS FOR AN AUTOMATIC IDENTIFICATION SYSTEM (AIS) HEADS UP DISPLAY

(71) Applicant: UNIVERSITY OF HAWAI'I, Honolulu, HI (US)

(72) Inventors: Baseem Missaghi, Honolulu, HI (US); Noah Hafner, Honolulu, HI (US)

(21) Appl. No.: 17/874,487

(22) Filed: Jul. 27, 2022

Related U.S. Application Data
(60) Provisional application No. 63/226,090, filed on Jul. 27, 2021.

(51) Int. Cl. G06T 11/00; G01S 19/13; G02B 27/01

(52) U.S. Cl. CPC G06T 11/001; G01S 19/13; G02B 27/0101; G08G 3/00

(57) ABSTRACT

A system for sensing maritime position and visualization includes an imaging device configured to capture an image including a vessel, a receiver configured to receive a first geospatial position of a user device and/or a compass heading of the user device, an Automatic Identification System (AIS) receiver configured to receive an AIS message, a processor, and a memory. The AIS message includes a second geospatial position of the vessel. The memory includes instructions, which, when executed by the processor, cause the system to capture an image of the vessel, receive a position and a heading of the user device, receive the AIS message, match the vessel in the captured image with the vessel identifier and the second geospatial position of the vessel of the AIS message, and generate an augmented reality marker based on the vessel identifier and the second geospatial position of the vessel of the AIS message.

### CROSS-REFERENCE TO RELATED APPLICATION AND CLAIM OF PRIORITY

This application claims the benefit of, and priority to, U.S. Provisional Patent Application No. 63/226,090 filed on Jul. 27, 2021. The entire contents of which are hereby incorporated herein by reference.

### GOVERNMENT SUPPORT

This invention was made with government support under N00024-08-D-6323 awarded by the U.S. Navy. The government has certain rights in the invention.

### TECHNICAL FIELD

The present disclosure relates generally to the field of sensing maritime position and visualization. More specifically, an aspect of the present disclosure provides systems and methods for an augmented reality based automatic identification system (AIS) heads up display (HUD).

### BACKGROUND

Maritime vessel operations in dense surface-traffic environments such as ports and harbors are challenging. The degree of risk depends upon multiple factors ranging from environmental conditions to operator experience. To assist with close-quarter maneuvering, the Automatic Identification System (AIS) was developed in the 1990s. As described by the United States Coast Guard (USCG), AIS is a shipboard broadcast system that acts like a transponder operating in the very high frequency (VHF) radio band. It is capable of handling over 4,500 vessel reports per minute and updates as often as every two seconds. AIS transponders fall into two classes: Class A, higher capability units installed in generally commercial vessels, and Class B, lower cost units, often used for smaller vessels. Both classes of transponders operate on marine VHF radio channels AIS 1 and 2. Messages broadcast for both classes of AIS include static information such as the maritime mobile service identity (MMSI), length and beam of the vessel, and dynamic data such as vessel location, speed, and heading. Typically, AIS Class A messages broadcast vessel location more frequently than AIS Class B data; however, Class B systems are frequently used because they are less expensive and require less power.

Accordingly, there is interest in sensing maritime position and visualization.

### SUMMARY

The present disclosure relates generally to the field of sensing maritime position and visualization. More specifically, an aspect of the present disclosure provides systems and methods for an augmented reality based automatic identification system (AIS) heads up display (HUD). An aspect of the present disclosure provides a system for sensing maritime position and visualization. The system includes an imaging device configured to capture a real-time image including a vessel, a receiver configured to receive a first geospatial position of a user device and/or a compass heading of the user device, an Automatic Identification System (AIS) receiver configured to receive an AIS message, a processor, and a memory. The AIS message includes a second geospatial position of the vessel and a vessel identifier. The memory includes instructions stored thereon, which, when executed by the processor, cause the system to capture a real-time image of the vessel by the imaging device, receive a geospatial position and a heading of the user device, receive the AIS message from the AIS receiver, match the vessel in the captured image with the vessel identifier and the second geospatial position of the vessel of the AIS message, and generate an augmented reality (AR) marker based on the vessel identifier and the second geospatial position of the vessel of the AIS message.

In an aspect of the present disclosure, the instructions, when executed by the processor, may further cause the system to generate an AR image based on the captured image. The AR image includes the captured image and the AR marker.

In another aspect of the present disclosure, the instructions, when executed by the processor, may further cause the system to display the generated AR image on the display of the user device.

In yet another aspect of the present disclosure, the instructions, when executed by the processor, further cause the system to determine a vessel name based on comparing the vessel identifier to a database of vessel names associated with vessel identifiers and display the vessel name on the real-time AR image.

In an aspect of the present disclosure, the database may be local or remote.

In accordance with further aspects of the present disclosure, the instructions, when executed by the processor, may further cause the system to determine a distance of the vessel from the user device.

In an aspect of the present disclosure, the AR marker may include a color based on the determined distance.

In another aspect of the present disclosure, the AR marker may include a size based on the determined distance.

In yet another aspect of the present disclosure, the instructions, when executed by the processor, may further cause the system to display a constant feed of system health and/or connection strength.

In yet another aspect of the present disclosure, the AIS message may further include at least one of a vessel name, a vessel speed, or a vessel heading.

In aspects, a computer-implemented method for sensing maritime position and visualization includes capturing a real-time image of a vessel by an imaging device of a user device, receiving a first geospatial position and a heading of the user device, and receiving an Automatic Identification System (AIS) message from an AIS receiver configured to receive the AIS message. The AIS message includes a vessel identifier and a second geospatial position of the vessel. The method further includes matching the vessel in the captured image with the vessel identifier and the second geospatial position of the vessel of the AIS message and generating an augmented reality (AR) marker based on the vessel identifier and the second geospatial position of the vessel of the AIS message.

In an aspect of the present disclosure, the computer implemented method may further include generating a real-time AR image based on the captured image. The AR image includes the captured image and the AR marker.

In another aspect of the present disclosure, the computer-implemented method may further include displaying the generated real-time AR image on the display of the user device.

In yet another aspect of the present disclosure, the computer-implemented method may further include determining a vessel name based on comparing the vessel identifier to a database and displaying the vessel name on the real-time AR image.

In accordance with further aspects of the present disclosure, the computer-implemented method may further include determining a distance of the vessel from the user device based on the geospatial position.

In an aspect of the present disclosure, the computer-implemented method may further include color coordinating AR markers based on the determined distance.

In another aspect of the present disclosure, the computer-implemented method may further include generating a size of the AR marker based on the determined distance.

In yet another aspect of the present disclosure, the computer-implemented method may further include displaying a constant feed of system health and/or connection strength.

In yet another aspect of the present disclosure, the computer-implemented method may further include displaying a vessel name, a vessel speed, and/or a vessel heading.

In aspects, a non-transitory computer-readable medium storing instructions which, when executed by a processor, cause the processor to perform a computer-implemented method for sensing maritime position and visualization is presented. The method includes capturing a real-time image of a vessel by an imaging device of a user device, receiving a first geospatial position and a heading of the user device, and receiving an Automatic Identification System (AIS) message from an AIS receiver configured to receive the AIS message. The AIS message includes a vessel identifier and a second geospatial position of the vessel. The method further includes matching the vessel in the captured image with the vessel identifier and the second geospatial position of the vessel of the AIS message, generating an augmented reality (AR) marker based on the vessel identifier and the second geospatial position of the vessel of the AIS message, generating a real-time AR image based on the captured image, and displaying the generated real-time AR image on the display of the user device. The AR image includes the captured image and the AR marker.

Further details and aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of a non-contact system for the sensing of maritime position and visualization, in accordance with aspects of the disclosure;

FIG. 2 is a block diagram of a controller configured for use with the system of FIG. 1, in accordance with aspects of the disclosure;

FIG. 3 is a flow diagram of a computer-implemented method for sensing maritime position and visualization, in accordance with aspects of the present disclosure;

FIG. 4 is a diagram depicting the orientation of the x, y, and z axes in the Automatic Identification System Heads Up Display (AISHUD), in accordance with aspects of the present disclosure;

FIG. 5 is an example augmented reality image displayed on the user interface of the system of FIG. 1, in accordance with aspects of the present disclosure; and

FIG. 6 is an example augmented reality image displayed on the user interface of the system of FIG. 1, in accordance with aspects of the present disclosure.

### DETAILED DESCRIPTION

The present disclosure relates generally to the field of sensing maritime position and visualization. More specifically, an aspect of the present disclosure provides systems and methods for an augmented reality based automatic identification system (AIS) heads up display (HUD).

Aspects of the present disclosure are described in detail with reference to the drawings wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

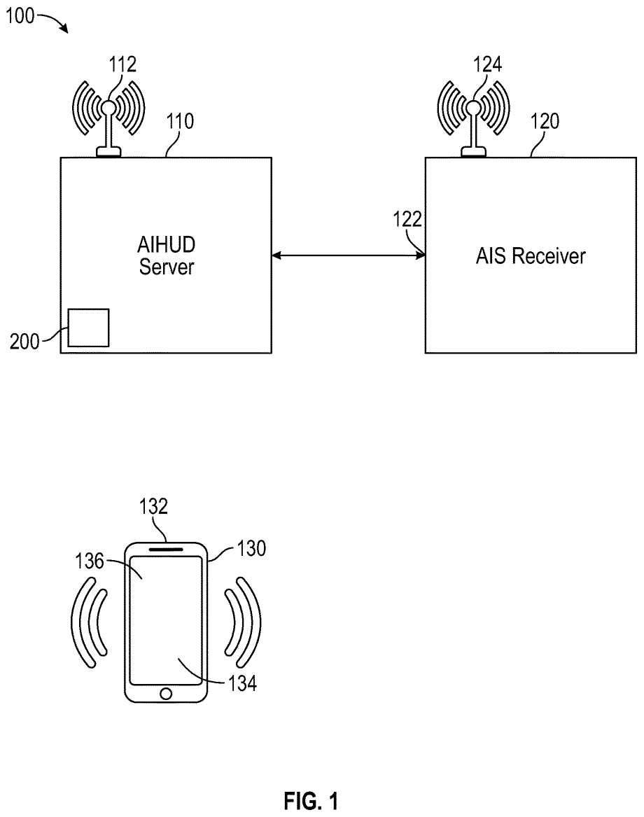

Referring to FIG. 1, a system 100 for sensing maritime position and visualization is shown. The system 100 generally includes an Automatic Identification System (AIS) receiver 120, an AIS heads-up display (AISHUD) server 110, and a visualization client application 136 that runs on a user device 130. The AISHUD server 110 includes a controller 200 and a wireless transceiver 112. The wireless transceiver 112 is configured to enable wireless communication (e.g., Bluetooth® and/or WiFi®) between the AISHUD server 110 and a user device.

The AIS receiver 120 is configured to receive AIS messages. The AIS receiver 120 includes a data connection 122 and an antenna 124 (e.g., a high gain dual band antenna) configured to wirelessly receive AIS messages. The data connection 122 is configured for data communications between the AISHUD server 110 and the AIS receiver 120. The data connection 122 may, for example, include a USB connection. The AIS receiver 120 may receive on one or more channels simultaneously. For example, the AIS receiver 120 may receive on channel A (161.975 MHz) and channel B (162.025 MHz) simultaneously. The antenna 124 is configured to wirelessly receive AIS messages. The AIS messages include data in standard National Marine Electronics Association (NMEA) format (AIVDM). In aspects, the AIS receiver may include a GPS receiver for receiving location data. The GPS-based location data may be fused with the AIS messages.

AIS messages provide multiple types of information, such as position reports (e.g., messages 1, 2, 3, and 18) and static data reports (e.g., messages 5 and 24). Messages 1, 2, and 3 provide AIS Class A position reports approximately every two to ten seconds while underway and approximately every three minutes while the vessel is at anchor and operating with sufficiently high power. Message 18 provides analogous position reports for AIS Class B data. Vessel position data may include latitude and longitude coordinates for the vessel. The position information may be sourced from a shipboard Global Navigation Satellite System (GNSS) and/or GPS receiver. Message 5 is broadcast approximately every 6 minutes and is used to acquire vessel names via the MMSI for AIS Class A data. Message 24 provides similar information for AIS Class B data.

The AISHUD server 110 is configured to decode NMEA messages and provide vessel name, position, speed, and heading when available. Because the vessel name is updated infrequently, the AISHUD server 110 may include a Maritime Mobile Service Identity (MMSI) database that may be used to match vessel names with MMSI numbers since the latter are reported more frequently. The AISHUD server 110 may use the MMSI to look up vessel name matches within an in-memory and/or remote database. For example, a preloaded database may contain over about 65,000 entries of recorded MMSIs and may be easily expandable upon acquisition of new data. MMSI is a unique nine-digit number that is assigned to a (Digital Selective Calling) DSC radio or an AIS transmitter. In aspects, the AISHUD server 110 may be configured to parse the NMEA sentences and convert the NMEA sentences to JavaScript Object Notation (JSON) for a visualization client application 136.

The system 100 may further include a user device 130 that is configured to run the visualization client application 136. The user device 130 may be, for example, a mobile device, a tablet, a laptop, and/or a desktop computer. The user device 130 may include an imaging device 132 and/or a display 134.

The visualization client application 136 is configured to provide a user interface with an AR image to be displayed on display 134. The user interface may display information such as vessel name, position, speed, and/or heading. The visualization client application 136 may generate augmented reality (AR) markers indicating maritime vessels. In aspects, rather than displaying text for every AR marker at all times, the name, speed, and heading for a vessel may be shown when the user selects an AR marker by tapping on the AR marker.

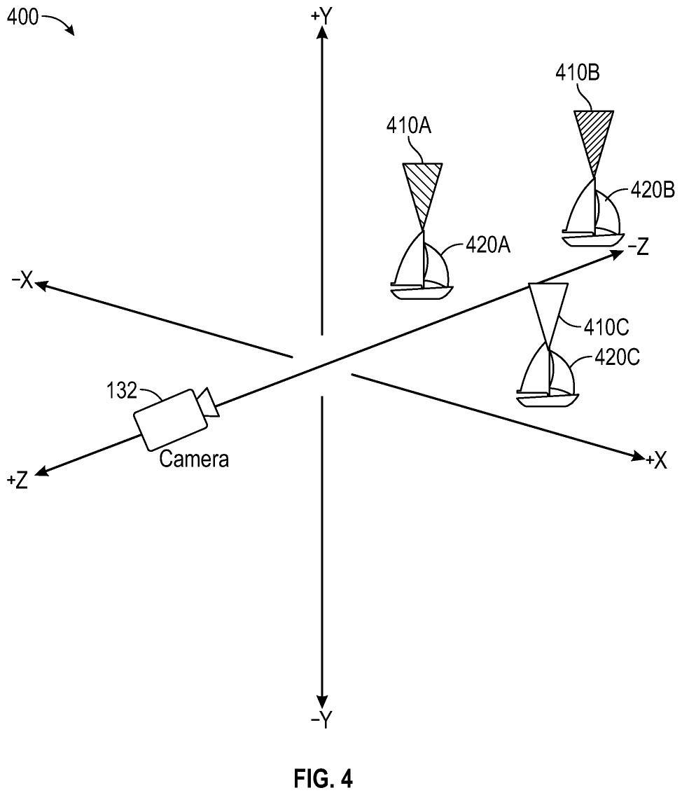

AR markers may include different colors to convey information such as distance. For example, the system 100 may sort nearby vessels into three categories-based proximity. In the AR image of the visualization client application 136, the AR markers may be indicated by color. For example, a red marker may indicate the vessel is less than about one mile from the user's (e.g., observer) position; a yellow marker may indicate the vessel is about 1-2 miles from the user's position; and a green marker may indicate that vessel is less than about two to three miles from the user's position. AR markers may be displayed on the x, y, and z-axes, where the z-axis represents the distance between the user device and a vessel (FIG. 4). The visualization client application 136 may enable a user to adjust the position on the y-axis as well as increasing the scale of markers so that markers located at a greater distance will be more visible.

The visualization client application 136 may also provide a constant feed of AISHUD server 110 health and connection, along with data freshness, i.e., a measure of how recently the information has been updated for each vessel when selected. The visualization client application 136 enables AR markers to quickly be filtered by color. A user may increase the scale of all markers to make them more visible. AR marker size may be modified to be a better representation of distance, such that the larger the AR marker becomes, the closer the vessel that the AR marker represents. In aspects, AR markers may be dynamically resized. For example, when AR markers in the interface foreground are so large that they effectively hide AR markers for vessels farther away, the markers representing more distant vessels may be scaled so that they become clearly noticeable.

Initially, the visualization client application 136 obtains the current user location, which may be associated with an initial accuracy score. For example, the accuracy may be highest when there are no obstructions (e.g., walls, trees, roofs) above or near the user.

Approximately every three seconds, the location of the device is updated, which impacts AR marker locations in the visualization client application.

For the visualization client application 136, AR marker positions may be based on the relative location of nearby vessels calculated from the AIS-reported vessel position and the GPS-based user/device location. These geographic positions may be converted into AR space using these conversions: longitude radius=(longitude/180.0*7c); latitude radius=(latitude/180.0*7c); x index=Earth radius*longitude radius; z index=Earth radius*log((sin(latitude radius)+1/cos(latitude radius)); marker final position z-index=marker point z-index−device point z-index; and marker final position x-index=marker point x-index−device point x-index.

In aspects, the AR markers may be scaled in size to communicate distance more effectively between a user and the observed vessel. For example, as the distance between the user device and a particular vessel increases, the scale also increases to ensure markers remain visible. For example, the scaling may be set to a constant 3%, which may be multiplied by the distance between the user device and the vessel (i.e., in meters).

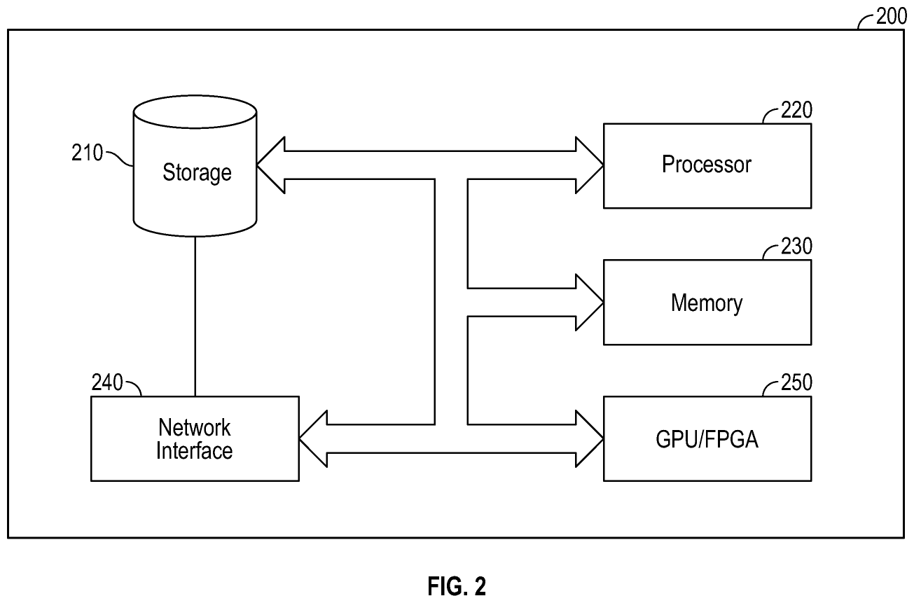

FIG. 2 illustrates controller 200 which includes a processor 220 connected to a computer-readable storage medium or a memory 230. The controller 200 may be used to control and/or execute operations of the system 100. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 may be random access memory, read-only memory, magnetic disk memory, solid-state memory, optical disc memory, and/or another type of memory. In some aspects of the disclosure, the memory 230 may be separate from the controller 200 and may communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data. The disclosed method may run on the controller 200 or on a user device, including, for example, on a mobile device, an IoT device, or a server system.

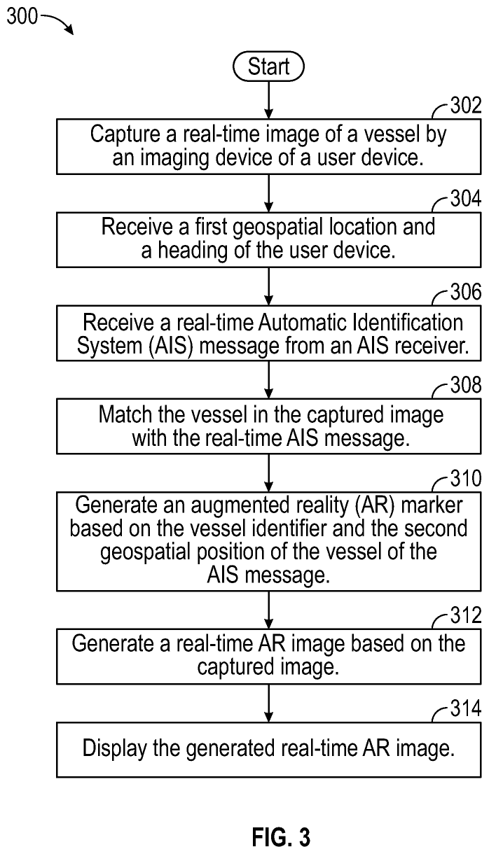

Referring to FIG. 3, a flow diagram for a method in accordance with the present disclosure for sensing maritime position and visualization is shown as 300. Although the steps of FIG. 3 are shown in a particular order, the steps need not all be performed in the specified order, and certain steps may be performed in another order. For example, FIG. 3 will be described below, with a controller 200 of FIG. 2 performing the operations. In aspects, the operations of FIG. 3 may be performed all or in part by another device, for example, a server, a mobile device, such as a smartphone, and/or a computer system. These variations are contemplated to be within the scope of the present disclosure.

Initially, at step 302, the controller 200 receives a real-time image of a vessel captured by an imaging device. For example, the imaging device may be the camera on a user device 130 (e.g., a cell phone camera). The real-time image includes real-time video.

Next, at step 304, the controller 200 receives a first geospatial position and a heading of the user device 130. For example, the controller may receive GPS coordinates and compass heading of the user's cell phone.

Next, at step 306, the controller 200 receives an Automatic Identification System (AIS) message from an AIS receiver 120. The AIS message may include vessel name, vessel identifier (e.g., AIS number), geospatial position (e.g., vessel position), speed, and/or heading.

Next, at step 308, the controller 200 matches the vessel in the captured image with the vessel identifier and the second geospatial position of the vessel of the AIS message.

In aspects, the controller 200 may determine the vessel name based on comparing the vessel identifier to a database of vessel names associated with vessel identifiers. The database may be local or remote. The controller 200 may cause the user device to display the vessel name on the real-time AR image.

Next, at step 310, the controller 200 generates an augmented reality (AR) marker based on the vessel identifier and the second geospatial position of the vessel of the AIS message. In aspects, the controller 200 may determine a distance of the vessel from the user device. The determined distance may be based on the user device's geospatial position, the AIS message (e.g., vessel position data), and/or GPS data for the vessel. For example, the controller 200 may receive an AIS message that indicates the vessel position, and the controller 200 may determine that the vessel is less than about 1 mile away from the user device.

In aspects, the AR marker may include a color based on the determined distance.

For example, the vessel may be about 1 mile away from the user device, and the AR marker may be red. The AR marker may include a size based on the determined distance. For example, the AR marker may be scaled to be larger for closer vessels and smaller for further vessels, to minimize obstruction of the vessel in the image.

Next, at step 312, the controller 200 generates an AR image based on the captured image. The augmented image includes the captured image and the AR marker.

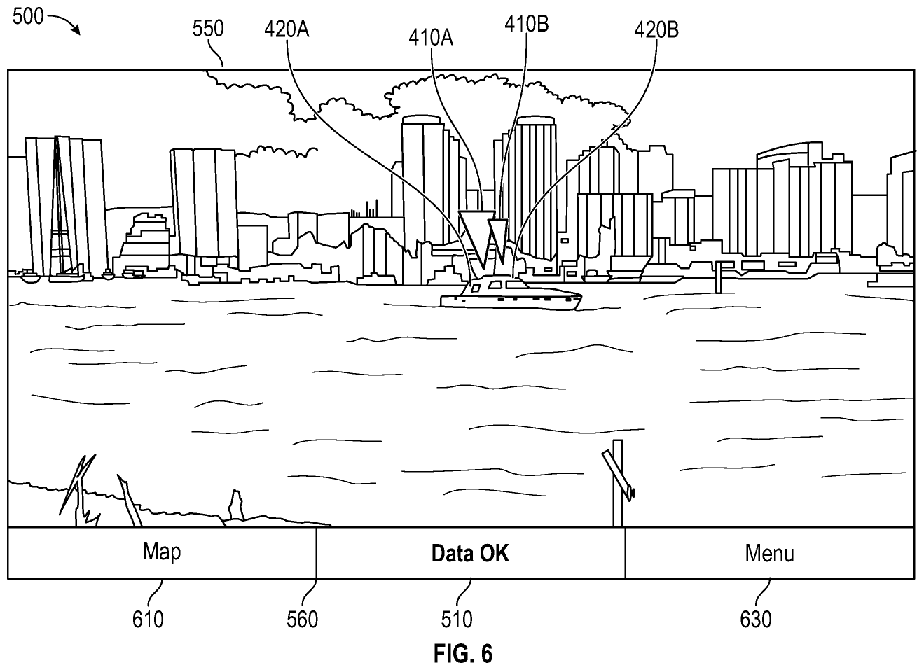

Next, at step 314, the controller 200 causes the user device to display the generated AR image on the display of the user device 130. For example, the user interface 500 may display the vessel 420A and a red AR marker 410A (FIG. 6). In aspects, the controller 200 may cause the user device 130 to display a constant feed of system health and/or connection strength for the AIS receiver 120 and/or AISHUD server 110.

Referring to FIG. 4, a diagram illustrating a depiction of the orientation of the x, y, and z-axes of the AR image is shown. The vessels 420A, 420B, 420C may have different color AR markers 410A, 410B, 410C (e.g., red, yellow, and green AR markers) based on vessel proximity to a user device's position indicated by the camera icon 430. The visualization client application 136 may sort nearby vessels into categories (e.g., three categories) based on proximity, such as a first AR marker that indicates vessel is less than about one mile from the user device's position; a second AR marker indicates the vessel is about 1-2 miles from the user device's position; and a third AR marker that indicates the vessel is greater than about two to three miles from the user device's position. Although three categories are given as an example, any number of suitable categories may be used. Markers are displayed on the x, y, and z-axes, where the z-axis represents the distance between the user device and a vessel. The visualization client application 136 enables the user to adjust the position on the y-axis as well as increase the scale of markers so that markers located at a greater distance will be more visible.

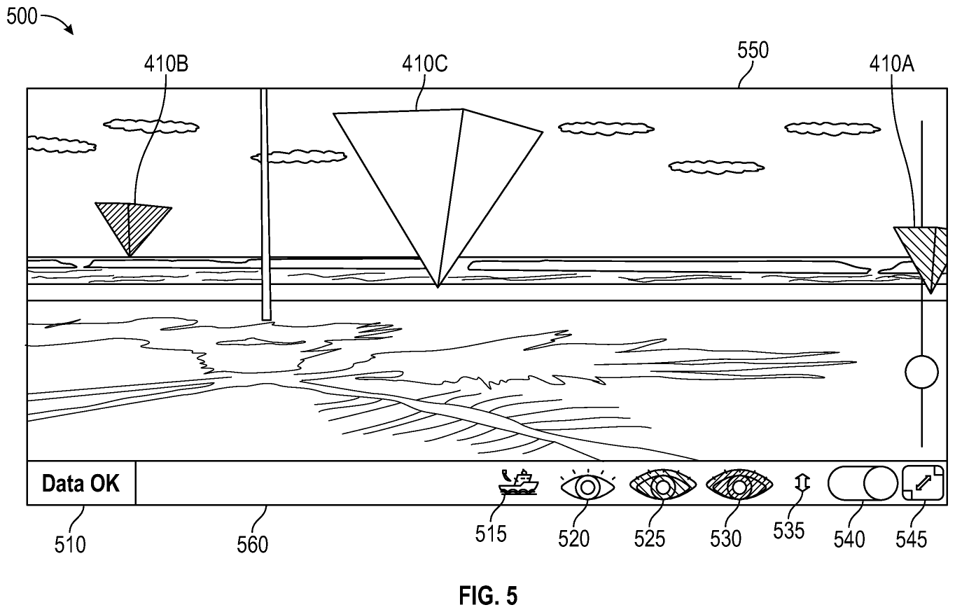

FIG. 5 is a user interface 500 of the visualization client application 136 showing three different colors of AR markers 410A-C that are visible to the user. The user interface 500 generally includes a main display area 550 where the AR image may be displayed, and a control area 560 that contains buttons and/or objects configured for user interaction and the selection of options.

In aspects, a user may select features (e.g., objects and/or buttons) typically located at the bottom of the user interface 500 to alter the viewing experience. It is contemplated that the features may be located at any suitable position on the user interface 500. The user interface 500 displays a first object 510 (e.g., Data OK), second object 515 (e.g., vessel information icon), third object 520 (e.g., red AR marker icon), fourth object 525 (e.g., yellow AR marker icon), fifth object 530 (e.g., green AR marker icon), sixth object 535 (e.g., user interface 500 height readjustment feature), seventh object 540 (e.g., AR marker 410A-C on/off feature), and an eighth object 545 (e.g., user interface 500 widening feature). A user may press first object “Data OK” 510 to accept the data that has been displayed on the user interface 500. A user may extract specific vessel information by selecting the second object 515 (e.g., vessel icon) on the user interface 500. In addition, a user may alternate between viewing the different color AR markers 410A, 410B, 410C (e.g., red, yellow, and green AR markers) based on vessel proximity by alternating between user interface third 520, fourth 525, and fifth 530 objects. The different color AR markers 410A, 410B, 410C (e.g., red, yellow, and green AR markers) may be turned on and off by selecting seventh object 540 on the user interface 500. When the seventh object 540 displays a green color, AR markers 410A, 410B, 410C (e.g., red, yellow, and green AR markers) are displayed on the user interface 500.

In aspects, a user may also alter the dimensions of the user interface 500 by either expanding the height of the user interface 500 by selecting sixth object 535 or by widening the user interface 500 by selecting eighth object 545 on the user interface 500.

FIG. 6 is a user interface 500 of the visualization client application 136 showing a vessel 420A accompanied by AR marker 410A, indicating that the vessel 420A is within about a mile of the position of the user device (e.g., observer's position). The visualization client application 136 AR display shows a vessel 420B accompanied by AR marker 410B, indicating that the vessel 420B is within about 1-2 miles of the position of the user device (e.g., observer's position).

AR markers (e.g., in red) are displayed in augmented reality above a vessel based on AIS data acquired with the AIS receiver 120. For example, a red marker may signify that the vessel is within 1 mile of the user device. Many vessels in the harbor are unmarked because they were not transmitting AIS data and/or the AIS message status indicated the vessel indicated that the vessel was “moored.”

In aspects, the visualization client application 136 may update the user position and the point of interest (POI) position every second. For example, the visualization client application 136 may redraw the AR markers approximately every second to significantly reduce any positional drift.

In aspects, to provide accurate positions for AR markers, locations with unobstructed GPS views may be predetermined, providing the benefit of ensuring that AR markers are positioned correctly relative to the user device's actual coordinates.

In aspects, banners may be displayed near the top of the user interface 500 with the details describing a specific marker that was selected by the user. By displaying the banners near the top of the user interface 500, clutter in the user interface 500 may be reduced.

The user interface 500 displays a ninth object 610 (e.g., Map), first object 510 (e.g., Data OK), and a tenth object 630 (e.g., Menu). A user may access a map of the surrounding area by selecting the ninth object 610 on the user interface 500. In addition, a user may access the menu option by selecting the tenth object 630 on the user interface 500. For example, a user may press the first object “Data OK” 510 to accept the data that has been displayed on the user interface 500.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for sensing maritime position and visualization, the system comprising:
an imaging device configured to capture a real-time image including a vessel;
a receiver configured to receive a first geospatial position of a user device and/or a compass heading of the user device;
an Automatic Identification System (AIS) receiver configured to receive an AIS message, wherein the AIS message includes a second geospatial position of the vessel and a vessel identifier;
a processor; and
a memory including instructions stored thereon, which, when executed by the processor, cause the system to:
capture a real-time image of the vessel by the imaging device;
receive a geospatial position and a heading of the user device;
receive the AIS message from the AIS receiver;
match the vessel in the captured image with the vessel identifier and the second geospatial position of the vessel of the AIS message; and
generate an augmented reality (AR) marker based on the vessel identifier and the second geospatial position of the vessel of the AIS message.

2. The system of claim 1, wherein the instructions, when executed by the processor, further cause the system to generate an AR image based on the captured image, wherein the AR image includes the captured image and the AR marker.

3. The system of claim 1, wherein the instructions, when executed by the processor, further cause the system to display the generated AR image on the display of the user device.

4. The system of claim 1, wherein the instructions, when executed by the processor, further cause the system to:
determine a vessel name based on comparing the vessel identifier to a database of vessel names associated with vessel identifiers; and
display the vessel name on the real-time AR image.

5. The system of claim 4, wherein the database may be local or remote.

6. The system of claim 1, wherein the instructions, when executed by the processor, further cause the system to determine a distance of the vessel from the user device.

7. The system of claim 6, wherein the AR marker includes a color based on the determined distance.

8. The system of claim 6, wherein the AR marker includes a size based on the determined distance.

9. The system of claim 1, wherein the instructions, when executed by the processor, further cause the system to display a constant feed of system health and/or connection strength.

10. The system of claim 6, wherein the AIS message further includes at least one of a vessel name, a vessel speed, or a vessel heading.

11. A computer-implemented method for sensing maritime position and visualization, the method comprising:
capturing a real-time image of a vessel by an imaging device of a user device;
receiving a first geospatial position and a heading of the user device;
receiving an Automatic Identification System (AIS) message from an AIS receiver configured to receive the AIS message, wherein the AIS message includes a vessel identifier and a second geospatial position of the vessel;
matching the vessel in the captured image with the vessel identifier and the second geospatial position of the vessel of the AIS message; and
generating an augmented reality (AR) marker based on the vessel identifier and the second geospatial position of the vessel of the AIS message.

12. The computer-implemented method of claim 11, further comprising generating a real-time AR image based on the captured image, wherein the AR image includes the captured image and the AR marker.

13. The computer-implemented method of claim 12, further comprising displaying the generated real-time AR image on the display of the user device.

14. The computer-implemented method of claim 11, further comprising:
determining a vessel name based on comparing the vessel identifier to a database; and
displaying the vessel name on the real-time AR image.

15. The computer-implemented method of claim 11, further comprising determining a distance of the vessel from the user device based on the geospatial position.

16. The computer-implemented method of claim 15, further comprising color coordinating AR markers based on the determined distance.

17. The computer-implemented method of claim 15, further comprising generating a size of the AR marker based on the determined distance.

18. The computer-implemented method of claim 11, further comprising displaying a constant feed of system health and/or connection strength.

19. The computer-implemented method of claim 17, further comprising displaying at least one of a vessel name, a vessel speed, or a vessel heading.

20. A non-transitory computer-readable medium storing instructions which, when executed by a processor, cause the processor to perform a computer-implemented method for sensing maritime position and visualization comprising:
capturing a real-time image of a vessel by an imaging device of a user device;
receiving a first geospatial position and a heading of the user device;
receiving an Automatic Identification System (AIS) message from an AIS receiver configured to receive the AIS message, wherein the AIS message includes a vessel identifier and a second geospatial position of the vessel;
matching the vessel in the captured image with the vessel identifier and the second geospatial position of the vessel of the AIS message;
generating an augmented reality (AR) marker based on the vessel identifier and the second geospatial position of the vessel of the AIS message;
generating a real-time AR image based on the captured image, wherein the AR image includes the captured image and the AR marker; and
displaying the generated real-time AR image on the display of the user device.
